(19) United States
(12) Patent Application Publication
(10) Pub. No.: US 2006/0225947 A1
(43) Pub. Date: Oct. 12, 2006

(54) METHOD AND COMPUTER PRODUCT IN A STEERING ARRANGEMENT FOR A VEHICLE

(75) Inventor: Olle Nyberg, S-429 31 Kullavik (SE)

Correspondence Address: WHITE, REDWAY & BROWN LLP, PMB 285, 107 S. WEST STREET, ALEXANDRIA, VA, 22314, US

(73) Assignee: VOLVO BUSSAR AB, Goteborg (SE)

(21) Appl. No.: 11/421,681

(22) Filed: Jun. 1, 2006

Related U.S. Application Data
(63) Continuation of application No. PCT/SE04/01776, filed on Dec. 1, 2004.

(30) Foreign Application Priority Data
Dec. 17, 2003 (SE) 0303449-3

(51) Int. Cl. B62D 5/04

(52) U.S. Cl. 180/446

(57) ABSTRACT

A method in a steering arrangement for a vehicle includes a steering element connected to at least one wheel of the vehicle, with the steering angle of the wheel of the vehicle being controlled in response to a movement of the steering element. According to the method, the function is detected of a servo device connected to the steering arrangement, with the gear ratio between the movement of the steering element and the steering angle of the wheel of the vehicle being controlled in response to the function of the servo device.

### BACKGROUND AND SUMMARY

The present application is a continuation of International Application No. PCT/SE2004/001776, filed Dec. 1, 2004, which claims priority to SE 0303449-3, filed Dec. 17, 2003, both of which are incorporated by reference.

The present invention relates to a method in a steering arrangement for a vehicle, comprising a steering element connected to at least one wheel of the vehicle, with the steering angle of the wheel of the vehicle being controlled in response to a movement of the steering element. The invention also relates to a computer program and a computer program product in a steering arrangement for a vehicle.

Steering arrangements in heavy vehicles, such as buses and lorries, are normally provided with servo steering in order to make steering of the wheels easier. The servo steering comprises for this purpose a hydraulic pump, that is driven by the vehicle's propulsion motor, that pumps hydraulic oil that urges the steering in the direction in which the driver of the vehicle turns the vehicle's steering wheel. The ratio between the number of revolutions that the driver must turn the steering wheel between full steering lock positions from right to left is called the “gear ratio”—a high gear ratio thus means that relatively many revolutions of the steering wheel are required between the full lock positions. In a vehicle with servo steering, a relatively low gear ratio is normally selected as this means that the steering is more direct and it is more comfortable as the steering wheel needs to be turned less, for example when parking. Against the background of the above, it will be recognized that if the function of the servo steering is reduced or lost completely for some reason, for example in the event of a breakdown of the hydraulic pump or an engine stoppage, the resistance to turning of the steering wheel will be very high, which makes continued driving of the vehicle difficult. In order to solve this, a steering wheel is normally used with a relatively large diameter which is easier to turn than a steering wheel with a small diameter in the event of the function of the servo steering being reduced or lost. This results, however, in the disadvantage that the steering feels less direct and that the steering wheel takes up a relatively large amount of the limited space that constitutes the space for the driver.

Other types of servo steering are variants of so-called electrical servo steering, that is where the power from an electric motor is transferred to the steering arrangement in order to make steering of the wheels of the vehicle easier and in this way, as described above, to enable a relatively low gear ratio to be selected in combination with a steering wheel with a relatively small diameter. This results in the same problem as that which can arise with the hydraulic servo steering described above, that is to say if the function of the servo steering is reduced or lost completely for some reason, for example in the event of a fault in the electric motor, the resistance to turning of the steering wheel becomes very high, which makes continued driving of the vehicle difficult.

It is desirable to achieve a method in a steering arrangement for a vehicle that enables a steering wheel with a relatively small diameter to be used in combination with a relatively low gear ratio, even on heavy vehicles such as buses and lorries, without the resistance to turning of the steering wheel being too high, and thereby making continued driving of the vehicle difficult, if the function of the servo steering is reduced or lost completely for some reason.

In accordance with an aspect of the present invention, a method in a steering arrangement for a vehicle, comprising a steering element connected to at least one wheel of the vehicle, with a steering angle of a wheel of the vehicle being controlled in response to a movement of the steering element, is provided. The method includes detecting a function of a servo device connected to the steering arrangement, and controlling a gear ratio between a movement of the steering element and a steering angle of the wheel of the vehicle in response to the function of the servo device.

Thus an aspect of the invention relates to a method in a steering arrangement for a vehicle, comprising a steering element connected to at least one wheel of the vehicle, with the steering angle of the wheel of the vehicle being controlled in response to a movement of the steering element, with the function of a servo device connected to the steering arrangement being detected and with the gear ratio between the movement of the steering element and the steering angle of the wheel of the vehicle being controlled in response to the function of the servo device.

By function is meant here to what extent the servo device makes easier or reduces the force or turning moment that is required in order to achieve a certain movement of the steering element that is required in order to achieve a certain steering angle.

It is also desirable to compensate for the force that must be applied to the steering element in order to achieve a required steering angle upon the detection of reduced function of the servo device, by the gear ratio being increased by a factor corresponding to the reduction in function of the servo device, so that the force is less than a predetermined maximum level. By this means, it is possible to continue to drive the vehicle to its final destination, after which the vehicle is to be taken into the workshop for faultfinding, repairs and resetting of the gear ratio to a normal position.

According to an aspect of the present invention, the gear ratio is increased by a predetermined factor from a normal ratio to a higher ratio that corresponds to the servo device being completely out of action.

Accordingly, a simple device is required for controlling the gear ratio.

According to an alternative aspect of the present invention, the gear ratio is increased in steps, from a normal ratio to a higher ratio corresponding to the detected reduction in function of the servo device. The stepwise increase is preferably carried out in three or more steps. By this means, it is possible to make a good match of the gear ratio and it is thereby possible to compensate for the force that must be applied to the steering element in order to achieve a required steering angle of the wheels of the vehicle.

According to a further aspect of the present invention, the gear ratio is varied steplessly, from the normal ratio to a maximally increased ratio.

By this means, it is possible to compensate precisely for the force that must be applied to the steering element in order to achieve a required steering angle of the wheels of the vehicle in relation to the function of the servo device detected at each given moment.

According to an aspect, the gear ratio is increased from the normal ratio to a maximally increased ratio that corresponds to the function of the servo device being lost completely, by a factor in the range 1.2 to 3.5, preferably 1.25 to 2.25.

According to an aspect of the present invention, the function of the servo device is detected by a pressure sensor that detects the hydraulic pressure at the outlet of the hydraulic pump. Additional or alternative pressure sensors can also be arranged in other places in the hydraulic system in order, in this way, to provide a good indication of the function of the servo device.

According to an alternative aspect of the present invention, the function of an electrical servo device, comprising an electric motor, is detected by the speed and/or the power consumption of the motor being used as an indicator of the function of the servo device.

### BRIEF DESCRIPTION OF THE DRAWINGS

In the following, the invention will be described with reference to preferred embodiments and the attached drawings, in which

FIG. 1 shows a schematic perspective view of a steering arrangement for a vehicle according to the present invention,

FIG. 2 shows a flow chart that describes the method for a vehicle with a steering arrangement according to the present invention, and

FIG. 3 shows the steering angle as a function of the number of rotations of the steering wheel, with the servo device working and a normal gear ratio, and with the servo device not working and thus with a high gear ratio, according to the present invention.

### DETAILED DESCRIPTION

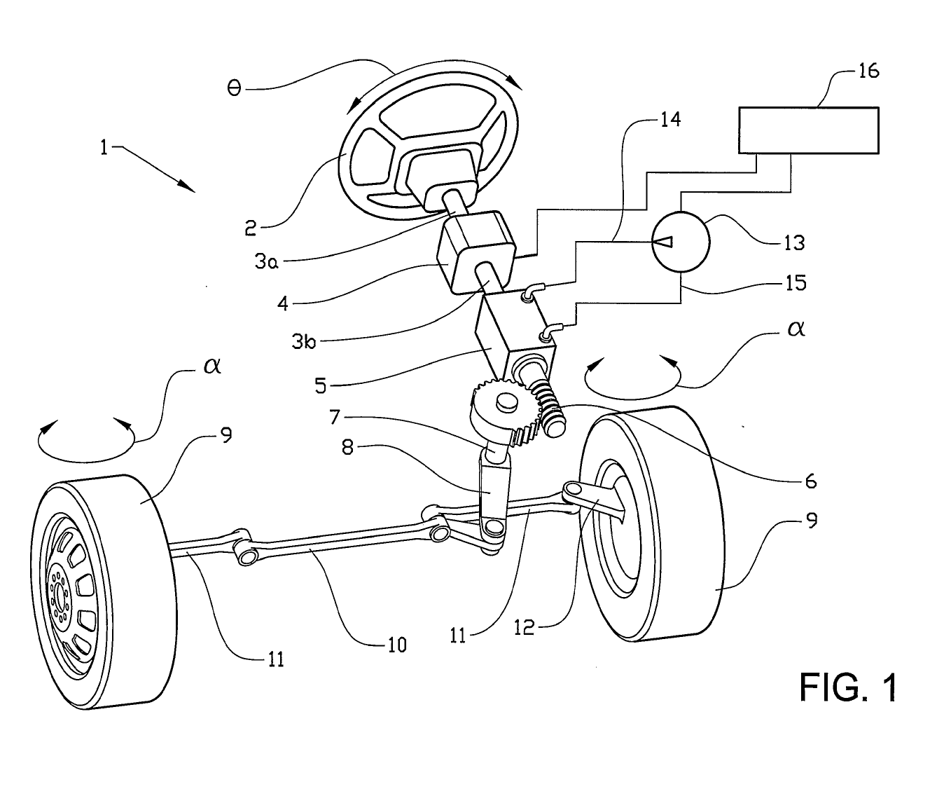

FIG. 1 shows a schematic view of an example of a steering arrangement 1 for a heavy vehicle, for example in the form of a bus or a lorry. The steering arrangement 1 comprises a steering wheel 2 which is connected, via an upper steering column 3a, to a variable transmission 4 which, in turn, is connected, via a lower steering column 3b, to a steering gear 5 of the worm gear type where the lower part 6 of the steering column 3b is designed as a worm that is in engagement with a corresponding worm wheel on a steering shaft 7. An arm 8 is arranged on the steering shaft 7, which arm is, in turn, connected to a rod 10 arranged between the wheels 9 of the vehicle, which rod 10 transfers movements of the steering wheel 0 to movements of the wheels via a drag link 11 and steering arms 12. In addition, a servo device 13 driven by the vehicle's propulsion motor (not shown), in the form of a hydraulic pump, is connected to the steering gear 5 via hydraulic pipes 14,15. Control of the gear ratio in the variable transmission 4 is carried out by a central electronic control unit 16, hereafter called an ECU, which sends a signal to the transmission 4 in response to the function of the servo device 13, with the function, for example, being indicated by a pressure sensor for detecting the hydraulic pressure at the outlet of the hydraulic pump. Additional or alternative pressure sensors can also be arranged in other places in the hydraulic system in order, in this way, to give a good indication of the function of the servo device. In addition, for an electrical for an electrical servo device, for example the speed and/or the power consumption of the electric motor can be used as an indicator of the function of the servo device. an electrical servo device, for example the speed and/or the power consumption of the electric motor can be used as an indicator of the function of the servo device.

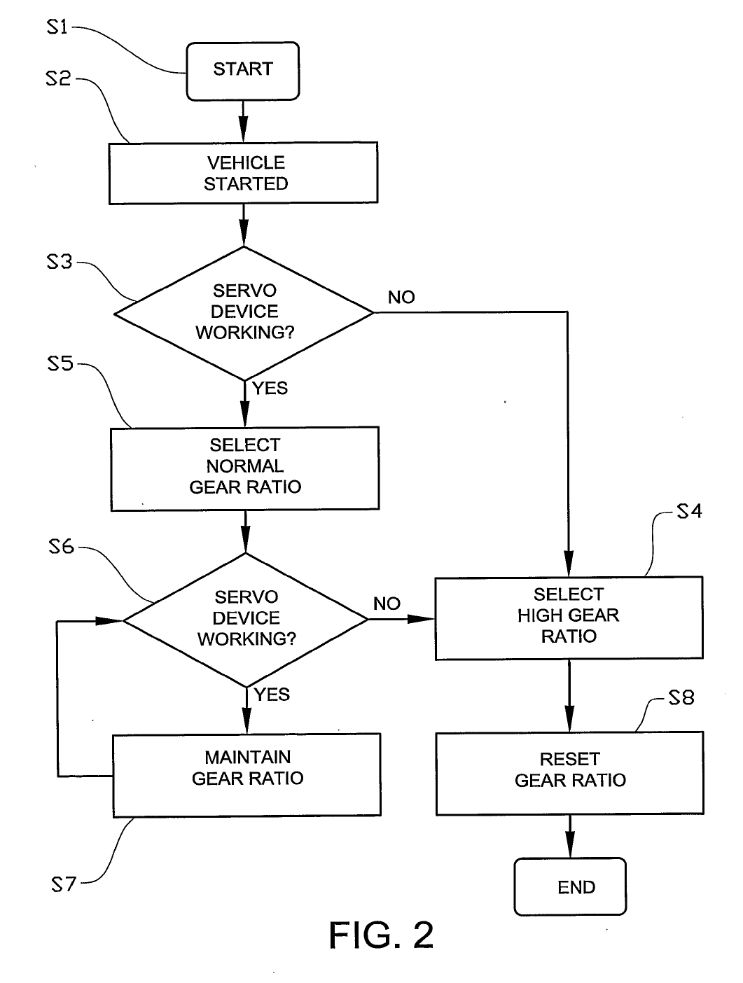

FIG. 2 shows a schematic illustration of a flow chart that describes the method for the steering arrangement.

The method starts S1 when the driver starts S2 the vehicle. The ECU detects S3 the function of the servo device. If the servo device is not working, the ECU selects S4 a high gear ratio by sending a signal to the variable transmission whereupon this is controlled so that a high gear ratio is obtained. By high gear ratio is meant here that the gear ratio is increased from a normal ratio by a factor in the range 1.2 to 3.5, preferably 1.25 to 2.25. If, however, the servo device is working, the ECU selects S5 a normal gear ratio in the variable transmission. Thereafter, the ECU continually detects S6 the function of the servo device and maintains S7 the gear ratio as long as the servo device is working. If, for some reason, during operation, the servo device is no longer working, the ECU selects S4 a high gear ratio, as described above.

Resetting of the gear ratio S8, after the servo device has not been working, is carried out after checks have been carried out in accordance with a predetermined routine. The method is thereby ended.

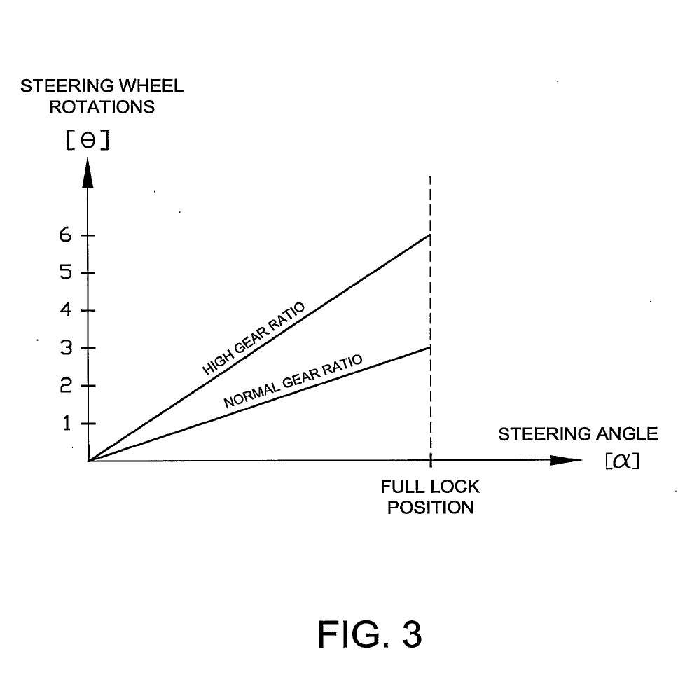

FIG. 3 shows examples of how the gear ratio affects the number of rotations of the steering wheel that are required between full lock positions. The lower line corresponds to a desired normal gear ratio where three rotations of the steering wheel are required between full lock positions, while the upper line shows a high gear ratio, in this case increased by a factor of two, which thus means that six rotations of the steering wheel are required in order to achieve the movement between full lock positions. When, as described above, the gear ratio is varied in steps, this corresponds to lines (not shown) between the lines illustrated and when the gear ratio is varied steplessly, this corresponds to the area between the lines, that is to say the gear ratio can assume all values between the lines.

The invention is not limited to the embodiments described above and illustrated in the drawings, other embodiments also being possible. For example, a steering gear of the rack and pinion type can be used instead of the steering gear of the worm gear type described above. In addition, the variable transmission can be integrated in the steering gear.

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While this invention has been illustrated and described in accordance with a preferred embodiment, it is recognized that variations and changes may be made therein without departing from the invention as set forth in the claims.

What is claimed is:

1. A method in a steering arrangement for a vehicle, comprising a steering element connected to at least one wheel of the vehicle, with a steering angle of a wheel of the vehicle being controlled in response to a movement of the steering element, comprising:
detecting a function of a servo device connected to the steering arrangement; and
controlling a gear ratio between a movement of the steering element and a steering angle of the wheel of the vehicle in response to the function of the servo device.

2. The method in a steering arrangement for a vehicle as claimed in claim 1, wherein the gear ratio is increased when reduced function of the servo device is detected.

3. The method in a steering arrangement for a vehicle as claimed in claim 2, wherein the gear ratio is increased from a normal ratio to a higher ratio.

4. The method in a steering arrangement for a vehicle as claimed in claim 2, wherein the gear ratio is increased in steps from a normal ratio to a higher ratio.

5. The method in a steering arrangement for a vehicle as claimed in claim 4, wherein the gear ratio is increased in at least three steps from a normal ratio to a higher ratio.

6. The method in a steering arrangement for a vehicle as claimed in claim 2, wherein control of the gear ratio is carried out steplessly, from a normal ratio to a higher ratio.

7. The method in a steering arrangement for a vehicle as claimed in claim 3, wherein the gear ratio is increased by a factor corresponding to a detected reduction in function of the servo device, and a force that is applied to the steering element in order to achieve a required steering angle being compensated so that the force is less than a predetermined maximum level at which it is possible to continue to drive the vehicle.

8. The method in a steering arrangement for a vehicle as claimed in claim 2, wherein the gear ratio is increased from a normal ratio to a higher ratio by a factor in the range of 1.2 to 3.5 when it is detected that the function of the servo device has been lost.

9. The method in a steering arrangement for a vehicle as claimed in claim 8, wherein the gear ratio is increased from a normal ratio to a higher ratio by a factor in the range of 1.25 to 2.25 when it is detected that the function of the servo device has been lost.

10. The method in a steering arrangement for a vehicle as claimed in claim 1, wherein the control of the gear ratio is carried out in a variable transmission.

11. The method in a steering arrangement a vehicle as claimed in claim 1, wherein the function of the servo device is detected by detecting oil pressure from a hydraulic pump comprising part of the servo device.

12. The method in a steering arrangement for a vehicle as claimed in claim 1, wherein the detection of the function of the servo device is carried out by detecting a speed of rotation of a shaft of an electric motor comprising part of the servo device.

13. The method in a steering arrangement for a vehicle as claimed in claim 1, wherein the detection of the function of the servo device is carried out by detecting the power consumption of an electric motor shaft comprising part of the servo device.

14. The method in a steering arrangement for a vehicle as claimed in claim 1, wherein the vehicle is a heavy vehicle.

15. The method in a steering arrangement for a vehicle as claimed in claim 1, wherein the steering element is a steering wheel.

16. A computer program comprising program code for carrying out all the steps in claim 1 when the program is executed by a computer.

17. A computer program product comprising program code stored on a medium that can be read by a computer, for carrying out all the steps in claim 1 when the computer program is executed by a computer.

18. A computer program product that can be downloaded directly into an internal memory in a digital computer, comprising a computer program for carrying out all the steps in claim 1 when the computer program is executed by the computer.
